(19) United States
(12) Patent Application Publication
(10) Pub. No.: US 2024/0032722 A1
(43) Pub. Date: Feb. 1, 2024

(54) Electric Pot Capable of Sterilizing Remaining Water

(71) Applicant: Haenim Co., Ltd., Incheon (KR)

(72) Inventor: Heung Bae Choi, Incheon (KR)

(73) Assignee: Haenim Co., Ltd., Incheon (KR)

(21) Appl. No.: 18/063,485

(22) Filed: Dec. 8, 2022

(30) Foreign Application Priority Data
Aug. 1, 2022 (KR) 10-2022-0095201

(51) Int. Cl. A47J 27/21; C02F 1/32

(52) U.S. Cl. CPC A47J 27/2105; A47J 27/21175; C02F 1/325; C02F 2303/04; C02F 2201/326

(57) ABSTRACT

The present disclosure provides an electric pot capable of sterilizing remaining water, the electric pot including a base to which power is supplied, a body having a water accommodation space defined by a bottom and a sidewall, and a heater provided in the bottom, and configured to set an upper plate of the bottom exposed to the water accommodation space as a heating plate heated by the heater, the body configured to be electrically connected to the base when being placed on the base and including a temperature sensor provided in the bottom and configured to detect a temperature of the upper plate of the bottom and output the temperature of the upper plate, and an ultraviolet emitting unit installed on the upper plate of the bottom and configured to emit ultraviolet rays to remaining water remaining in the water accommodation space, the ultraviolet emitting unit being configured to be controlled to emit the ultraviolet rays when there is a user's input notifying that the remaining water is present after heating of water accommodated in the water accommodation space is ended and when an output value of the temperature sensor is equal to or less than a preset reference value.

### FIELD

The present disclosure relates to an electric pot, and more particularly, to an electric pot capable of sterilizing remaining water.

### DESCRIPTION OF THE RELATED ART

An electric pot refers to a device used to heat water and generally includes a base and a body. When power is supplied to the base in a state in which the body is placed on the base, a bottom of the body is heated, and water accommodated in the body is heated. The heating of the water is ended when the water is heated to a preset temperature, and a user uses the heated water.

Examples of the electric pot are disclosed in Korean Utility Model Application Laid-Open No. 20-2012-0001681 (Electric Pot), Korean Patent Application Laid-Open No. 10-2018-0068689 (Electric Pot Capable of Sterilizing Nursing Bottle), Korean Patent Application Laid-Open No. 10-2021-0046403 (Electric Pot and Method of Operating the Same), and Korean Patent Application Laid-Open No. 10-2021-0158752 (Electric Pot with UV LED).

Korean Utility Model Application Laid-Open No. 20-2012-0001681 discloses a technology for adding a low-temperature or high-temperature maintaining function to an electric pot in addition to a basic function of heating water. Korean Patent Application Laid-Open No. 10-2018-0068689 discloses a technology for adding a function of sterilizing a nursing bottle to an electric pot in addition to a basic function of heating water. Korean Patent Application Laid-Open No. 10-2021-0046403 discloses a technology for adding a function of heating water only in case that the water remains in a body in addition to a basic function of heating water. Further, Korean Patent Application Laid-Open No. 10-2021-0158752 discloses a technology for adding a function of sterilizing water with ultraviolet rays even at the time of heating water at a low temperature in addition to a basic function of heating water.

### DOCUMENTS OF RELATED ART

### Patent Documents

Korean Utility Model Application Laid-Open No. 20-2012-0001681 (Electric Pot)
Korean Patent Application Laid-Open No. 10-2018-0068689 (Electric Pot Capable of Sterilizing Nursing Bottle)
Korean Patent Application Laid-Open No. 10-2021-0046403 (Electric Pot and Method of Operating the Same)
Korean Patent Application Laid-Open No. 10-2021-0158752 (Electric Pot with UV LED)

### SUMMARY

The user heats water by using the electric pot and uses the water. In this case, the user generally uses a part of the heated water and often leaves the remaining heated water in the body. Further, the residual water in the body, i.e., the remaining water is generally used again by the user later. However, there is a problem in that bacteria may grow in the remaining water for a period from when the heating is ended to when the remaining water is used again.

Accordingly, an object of the present disclosure is to provide a technology capable of sterilizing water remaining in a body of an electric pot without being used by a user after being heated by an electric pot.

The present disclosure provides an electric pot capable of sterilizing remaining water, the electric pot including: a base to which power is supplied; a body having a water accommodation space defined by a bottom and a sidewall, and a heater provided in the bottom, and configured to set an upper plate of the bottom exposed to the water accommodation space as a heating plate heated by the heater, the body configured to be electrically connected to the base when being placed on the base and including a temperature sensor provided in the bottom and configured to detect a temperature of the upper plate of the bottom and output the temperature of the upper plate; and an ultraviolet emitting unit installed on the upper plate of the bottom and configured to emit ultraviolet rays to remaining water remaining in the water accommodation space, the ultraviolet emitting unit being configured to be controlled to emit the ultraviolet rays when there is a user's input notifying that the remaining water is present after heating of water accommodated in the water accommodation space is ended and when an output value of the temperature sensor is equal to or less than a preset reference value.

The electric pot capable of sterilizing remaining water may include: a cover configured to open or close an upper opening side of the water accommodation space; a sensor support body installed on the base and positioned on an upper portion of the cover that closes the upper opening side of the water accommodation space; and a cover detection sensor installed on the sensor support body and configured to detect the cover that closes the upper opening side of the water accommodation space. Further, the ultraviolet emitting unit may be controlled to emit ultraviolet rays only when the cover detection sensor detects the cover that closes the upper op″ning′ side of the water accommodation space.

An input unit having input buttons may be provided on an upper surface of the sensor support body, and configured as a control panel embedded with the controller.

The cover detection sensor may be configured as an infrared distance sensor provided at a lower surface of the sensor support body.

The ultraviolet emitting unit may be controlled to emit the ultraviolet rays periodically for a preset operating time.

The ultraviolet emitting unit may include: a watertight body installed in an installation hole so as to ensure watertightness, the installation hole being formed in the upper plate of the bottom; a light transmission cap configured to penetrate the watertight body while being tightly fitted with the watertight body, the light transmission cap being made of a material capable of transmitting ultraviolet rays and having an upper surface exposed to the water accommodation space; a bracket including a support member positioned in the bottom, provided to be in contact with a lower end of the watertight body and a lower end of the light transmission cap, and separably coupled to the upper plate of the bottom, and a protruding member protruding upward from the support member and inserted into the light transmission cap; and a printed circuit board fixed to an upper surface of the protruding member and having an ultraviolet ray LED mounted thereon.

An O-ring may be interposed between an inner surface of the light transmission cap and an outer surface of the protruding member.

According to the present disclosure, the remaining water, which remains in the body of the electric pot without being used by the user after being heated by the electric pot, is automatically sterilized by the ultraviolet rays emitted from the ultraviolet emitting unit, and the deterioration in lifespan of the ultraviolet emitting unit is prevented.

In addition, according to the present disclosure, the ultraviolet rays are emitted only in case that the upper opening side of the body of the electric pot is sealed by the cover. There is no problem that the user's body is exposed to the ultraviolet rays emitted from the ultraviolet emitting unit.

In addition, according to the present disclosure, the ultraviolet emitting unit emits ultraviolet rays periodically for a preset operating time, which makes it possible to ensure excellent efficiency in sterilizing the remaining water while reducing the electric power required to operate the ultraviolet emitting unit.

In addition, according to the present disclosure, the ultraviolet emitting unit is separably installed in the installation hole of the upper plate of the bottom, which makes it easy to perform maintenance on the ultraviolet emitting unit. Further, the ultraviolet emitting unit includes the watertight body, which makes it possible to ensure watertightness in the installation hole.

In addition, according to the present disclosure, the printed circuit board and the ultraviolet LED of the ultraviolet emitting unit may be positioned in the watertight space assuredly sealed by the O-ring.

### BRIEF DESCRIPTION OF THE DRAWINGS

FIG. 1 is a perspective view illustrating an electric pot capable of sterilizing remaining water according to the present disclosure;

FIGS. 2 and 3 are perspective views illustrating a state in which a body in the FIG. 1 is not placed on a base;

FIGS. 4 and 5 are perspective views illustrating the body in FIG. 1;

FIG. 6 is a perspective view illustrating a lower surface of an upper plate of a bottom illustrated in FIG. 4;

FIG. 7 is an exploded perspective view illustrating an ultraviolet emitting unit illustrated in FIG. 4; and

FIG. 8 is a cross-sectional view illustrating a state in which the ultraviolet emitting unit in FIG. 7 is fastened to the upper plate of the bottom.

### DETAILED DESCRIPTION OF THE EMBODIMENT

Hereinafter, exemplary embodiments of an electric pot capable of sterilizing remaining water according to the present disclosure will be described in detail with reference to the drawings. Terms or words used herein should not be interpreted as being limited to general or dictionary meanings and should be interpreted as meanings and concepts which conform to the technical spirit of the present disclosure based on a principle that an inventor can appropriately define a concept of a term in order to describe his/her own invention by the best method.

As illustrated, an electric pot 100 capable of sterilizing remaining water according to the present disclosure includes a base 110, a body 120, a cover 140, an ultraviolet emitting unit 160, a cover detection sensor 154, an input unit, and a controller.

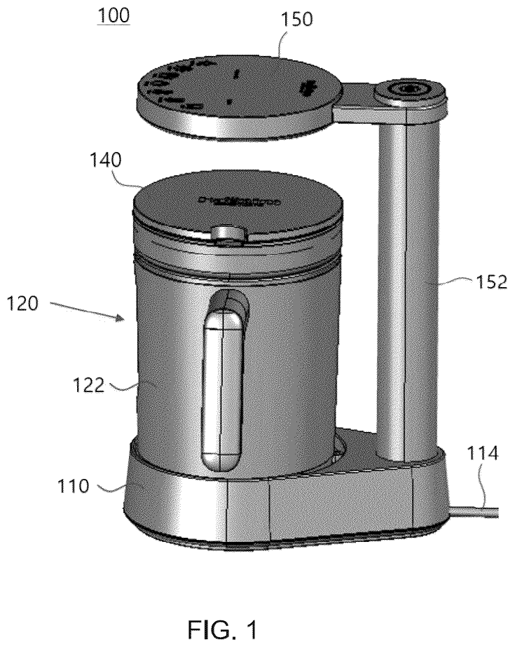

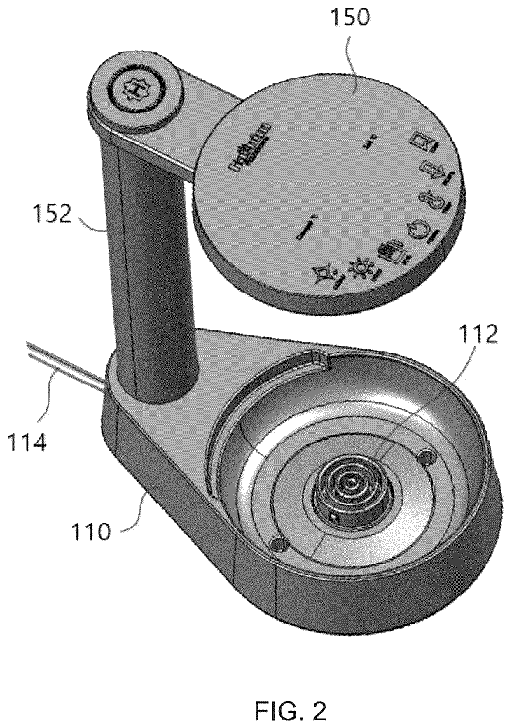

As illustrated in FIGS. 1 to 3, the base 110 is connected to a power line 114 for receiving commercial power. In addition, as illustrated in FIG. 2, an upper surface of the base 110 has a concave portion recessed downward. As illustrated in FIG. 1, the body 120 is placed in the concave portion. In addition, as illustrated in FIG. 2, a contact terminal 112 protruding upward is provided at an approximately center of the concave portion.

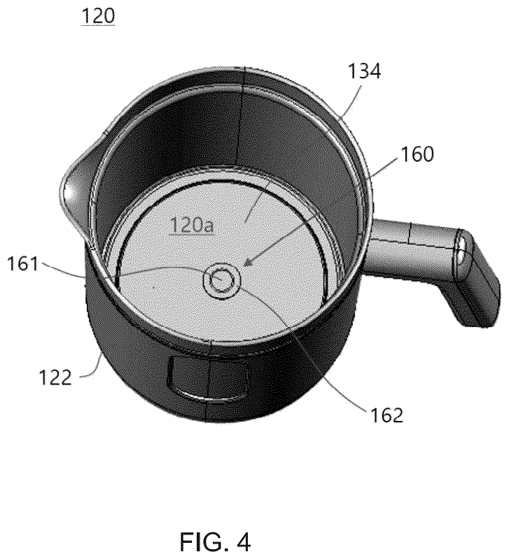

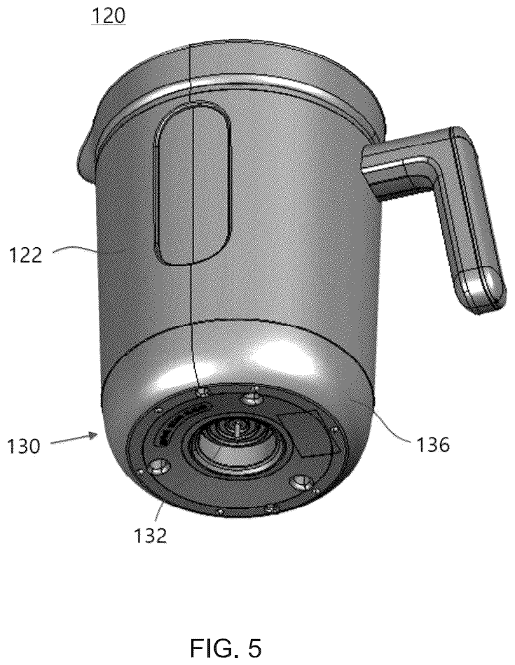

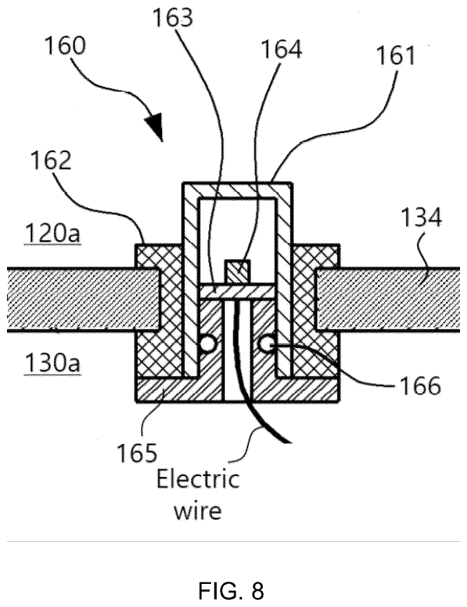

As illustrated in FIGS. 4 and 5, the body 120 has a water accommodation space 120a defined by a sidewall 122 and a bottom 130 separably coupled to the body 120. The water accommodation space 120a accommodates water to be heated. Further, the bottom 130 of the body 120 includes upper and lower plates 134 and 136 separably coupled to each other and has an internal space 130a (see FIG. 8) surrounded by the upper and lower plates 134 and 136.

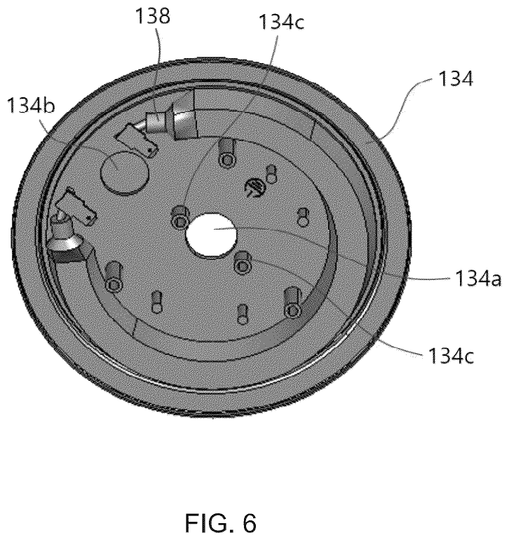

The upper plate 134 of the bottom 130 is exposed to the water accommodation space 120a and comes into contact with water accommodated in the water accommodation space 120a. Further, as illustrated in FIG. 6, a heater 138 is coupled to a lower surface of the upper plate 134 and positioned in the internal space 130a of the bottom 130. When the heater 138 operates, the upper plate 134 is heated, and the water accommodated in the water accommodation space 120a is also heated. As illustrated in FIG. 6, a fastening hole 134a is formed at a center of the upper plate 134 and fastened to the ultraviolet emitting unit 160. A coupling groove 134b is formed in the lower surface of the upper plate 134. A temperature sensor (not illustrated) is coupled to the coupling groove 134b and positioned in the internal space 130a of the bottom 130. The temperature sensor detects a temperature of the upper plate 134 and outputs the temperature.

As illustrated in FIG. 5, the lower plate 136 of the bottom 130 has a contact terminal 132. When the body 120 is placed on the base 110, the contact terminal 132 is electrically connected to the contact terminal 112 of the base 110 and also electrically connected to the temperature sensor (not illustrated) and the heater 138 positioned in the internal space 130a of the bottom 130. Therefore, power supplied to the base 110 may be supplied to the heater 138, and an output value of the temperature sensor (not illustrated) may be transmitted to the base 110.

The cover 140 serves to open or close an upper opening side of the water accommodation space 120a provided in the body 120. The user may close the upper opening side of the water accommodation space 120a by placing the cover 140 on an upper end of the body 120. The user may open the upper opening side of the water accommodation space 120a by raising the cover 140 from the upper end of the body 120.

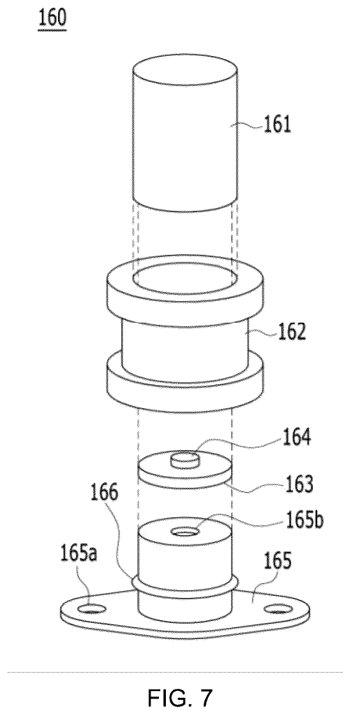

The ultraviolet emitting unit 160 is installed on the upper plate 134 of the bottom 130. As illustrated in FIGS. 7 and 8, the ultraviolet emitting unit 160 includes a watertight body 162, a light transmission cap 161, a bracket 165, and a printed circuit board 163.

The light transmission cap 161 is provided in the form of a hollow cap and made of a material (e.g., quartz glass) capable of transmitting ultraviolet rays.

The bracket 165 includes a support member provided in the form of a flat plate, and a protruding member protruding upward from an approximately center of the support member. A pair of bolt holes 165a is formed in the support member. Further, the protruding member has a hollow portion.

The printed circuit board 163 is fixed to an upper surface of the protruding member of the bracket 165 by a bonding agent. Further, an ultraviolet LED 164 is mounted on the printed circuit board 163. The power supplied to the contact terminal 132 provided on the lower plate 136 of the bottom 130 is supplied to the printed circuit board 163 through an electric wire, and the ultraviolet LED 164 operates and emits ultraviolet rays.

When the protruding member is inserted into the light transmission cap 161 until the support member comes into contact with a lower end of the light transmission cap 161, the bracket 165 to which the printed circuit board 163 is fixed is coupled to the light transmission cap 161. Further, when the bracket 165 and the light transmission cap 161 are coupled as described above, the printed circuit board 163 and the ultraviolet LED 164 are positioned in the light transmission cap 161. Therefore, the ultraviolet rays emitted from the ultraviolet LED 164 pass through the light transmission cap 161. Meanwhile, to ensure the watertightness of the printed circuit board 163 and the ultraviolet LED 164, an O-ring 166 is interposed between an outer surface of the protruding member and an inner surface of the light transmission cap 161.

The watertight body 162 is installed to be fitted with the installation hole 134a of the upper plate 134 and installed to be caught by the upper and lower surfaces of the upper plate 134. Further, the watertight body 162 has a hollow portion. The watertight body 162 is made of a material such as heat-resistance silicone or heat-resistance rubber so that the watertightness may be implemented in the installation hole 134a, and the watertight body 162 may withstand a heating temperature of the upper plate 134.

In the state in which the bracket 165 and the light transmission cap 161 are coupled and the watertight body 162 is installed in the installation hole 134a, the light transmission cap 161 penetrates the watertight body 162 while being tightly fitted with the hollow portion of the watertight body 162 until the support member of the bracket 165 comes into contact with the lower end of the watertight body 162. Thereafter, when bolts (not illustrated) passing through the bolt holes 165a of the support member are fastened to bolting fastening members 134c (see FIG. 6) formed on the lower surface of the upper plate 134, the ultraviolet emitting unit 160 is separably installed on the upper plate 134.

Further, when the ultraviolet emitting unit 160 is installed as described above, the upper surface of the light transmission cap 161 is exposed to the water accommodation space 120a of the body 120, as illustrated in FIGS. 4 and 8. Therefore, the ultraviolet rays passing through the light transmission cap 161 are emitted to the water remaining in the water accommodation space 120a.

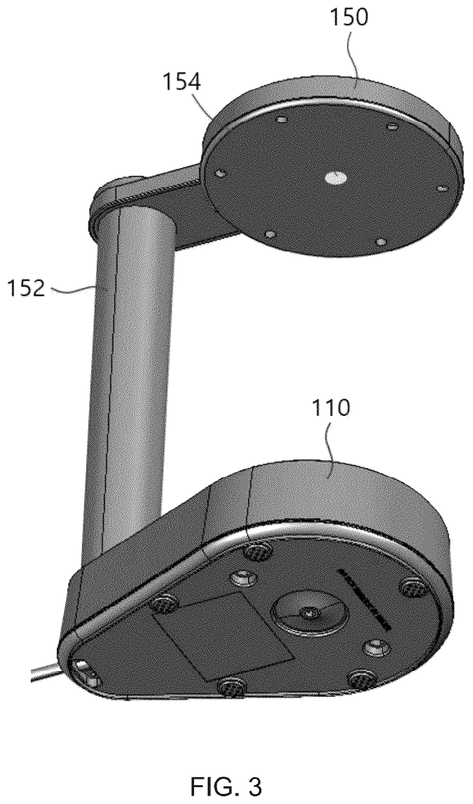

The cover detection sensor 154 serves to detect the cover 140 closing the upper opening side of the water accommodation space 120a, i.e., the cover 140 placed on the upper end of the body 120. As illustrated in FIG. 3, the cover detection sensor 154 is installed on a lower surface of a sensor support body 150. Further, as illustrated in FIGS. 1 to 3, the sensor support body 150 is coupled to an upper end of a column 152 coupled to the base 110 and positioned on an upper portion of the cover 140 placed on the upper end of the body 120. The column 152 is provided to accommodate an electric wire that electrically connects a member positioned on the sensor support body 150 and a member positioned on the base 110.

An infrared distance sensor having a light-emitting part and a light-receiving part may be used as the cover detection sensor 154. In this case, the light-receiving part receives infrared rays, which are emitted downward from the light-emitting part and then reflected, and changes an output depending on the amount of received infrared rays. Therefore, whether the cover 140 is placed on the upper end of the body 120 may be detected on the basis of an output value from the light-receiving part.

The input unit is provided to receive various types of instructions from the user. For example, as illustrated in FIG. 2, the input unit may include an on/off button for on/off instructions for the electric pot 100, and a storage button for an instruction for storing the remaining water. The user may leave the remaining water in the water accommodation space 120a after using the necessary amount of heated water. In this case, the user may push the storage button to notify that the remaining water is present. The electric pot 100 may have a function of storing the remaining water at a storage temperature. In this case, the input unit may also include a temperature setting button for setting the storage temperature.

The controller (not illustrated) entirely controls the electric pot 100 in response to the user's input inputted through the input unit and the outputs of the temperature sensor and the cover detection sensor 154. The controller may be configured as a printed circuit board on which electronic elements are mounted.

As illustrated in FIG. 2, the input unit is provided on an upper surface of the sensor support body 150, and the controller may be embedded in the sensor support body 150. In this case, the sensor support body 150 is configured as a control panel. Alternatively, the input unit and the controller may be provided on the base 110. In this case, the sensor support body 150 only serves to support the cover detection sensor 154.

A method of controlling the electric pot 100 by the controller will be described below.

First, the user fills the water accommodation space 120a of the body 120 with water and then closes the water accommodation space 120a by using the cover 140. Thereafter, the user inserts the body 120, which is filled with water, into the base 110 and operates the electric pot 100 by manipulating the on/off button of the input unit. When the electric pot 100 operates, the upper plate 134 of the bottom 130 is heated by the heater 138, and the water in the water accommodation space 120a is also heated by the heated upper plate 134. When the controller determines that a detected temperature, which is detected by the temperature sensor embedded in the bottom 130 of the body 120 while the water is heated, reaches a preset heating stop temperature (e.g., 100° C.), the controller stops the electric pot 100.

When the electric pot 100 is stopped, the user opens the cover 140 and uses the necessary amount of heated water, and then the user places the body 120 on the base 110 again. In this case, when the remaining water is present in the water accommodation space 120a, the user may select the storage button. Then, the controller determines that the remaining water is present in the water accommodation space 120a.

When the controller determines that the remaining water is present in the water accommodation space 120a, the controller consistently compares an output temperature detected and outputted by the temperature sensor with a preset reference temperature. When the output temperature becomes equal to or lower than the reference temperature, the ultraviolet emitting unit 160 operates, and the ultraviolet rays are emitted from the ultraviolet LED 164 and sterilize the remaining water. The emission of ultraviolet rays from the ultraviolet emitting unit 160 may be performed regardless of a temperature. However, when the ultraviolet emitting unit 160 repeatedly operates at a high temperature, there occurs a problem in that a lifespan of the ultraviolet emitting unit 160 decreases. Therefore, as described above, the ultraviolet emitting unit 160 operates only when the output temperature becomes equal to or lower than the reference temperature, which makes it possible to prevent the lifespan of the ultraviolet emitting unit 160 from deteriorating. In this case, the reference temperature may be set to a temperature of about 60 to 70° C. Further, the controller operates the ultraviolet emitting unit 160 periodically for a preset operating time (e.g., for one hour every one hour).

The controller does not operate the ultraviolet emitting unit 160 in case that the controller does not receive a signal indicating that the cover detection sensor 154 detects the cover 140 that closes the upper opening side of the water accommodation space 120a even though the controller determines that the remaining water is present, and the output temperature is equal to or lower than the reference temperature. If the ultraviolet emitting unit 160 operates in a state in which no cover 140 is present, the user's body is exposed directly to the ultraviolet rays emitted from the ultraviolet emitting unit 160 and detrimentally affected by the ultraviolet rays. Therefore, the ultraviolet emitting unit 160 operates only in case that the cover 140 closes the upper opening side of the water accommodation space 120a.

Meanwhile, as described above, the input unit may include the temperature setting button for setting the storage temperature of the remaining water. In this case, the controller consistently controls the operations of operating and stopping the heater 138 so that the temperature of the remaining water is maintained to be a storage temperature set by the user. In addition, as described above, the controller controls the ultraviolet emitting unit 160 only in case that the storage temperature set by the user is equal to or lower than the reference temperature. The controller does not operate the ultraviolet emitting unit 160 in case that the storage temperature set by the user exceeds the reference temperature.

The present disclosure has been described with reference to the limited exemplary embodiments and the drawings, but the present disclosure is not limited thereto. The described exemplary embodiments may be variously changed or modified by those skilled in the art to which the present disclosure pertains within the technical spirit of the present disclosure and within the scope equivalent to the appended claims, and the above-described exemplary embodiments may of course be variously combined.

What is claimed is:

1. An electric pot capable of sterilizing remaining water, the electric pot comprising:
a base to which power is supplied;
a body having a water accommodation space defined by a bottom and a sidewall, and a heater provided in the bottom, and configured to set an upper plate of the bottom exposed to the water accommodation space as a heating plate heated by the heater, the body configured to be electrically connected to the base when being placed on the base and including a temperature sensor provided in the bottom and configured to detect a temperature of the upper plate of the bottom and output the temperature of the upper plate; and
an ultraviolet emitting unit installed on the upper plate of the bottom and configured to emit ultraviolet rays to remaining water remaining in the water accommodation space, the ultraviolet emitting unit being configured to be controlled to emit the ultraviolet rays when there is a user's input notifying that the remaining water is present after heating of water accommodated in the water accommodation space is ended and when an output value of the temperature sensor is equal to or less than a preset reference value.

2. The electric pot of claim 1, comprising:
a cover configured to open or close an upper opening side of the water accommodation space;
a sensor support body installed on the base and positioned on an upper portion of the cover that closes the upper opening side of the water accommodation space; and
a cover detection sensor installed on the sensor support body and configured to detect the cover that closes the upper opening side of the water accommodation space,
wherein the ultraviolet emitting unit is controlled to emit ultraviolet rays only when the cover detection sensor detects the cover that closes the upper opening side of the water accommodation space.

3. The electric pot of claim 2, wherein an input unit having input buttons is provided on an upper surface of the sensor support body, and configured as a control panel embedded with the controller.

4. The electric pot of claim 2, wherein the cover detection sensor is configured as an infrared distance sensor provided at a lower surface of the sensor support body.

5. The electric pot of claim 1, wherein the ultraviolet emitting unit is controlled to emit the ultraviolet rays periodically for a preset operating time.

6. The electric pot of claim 1, wherein the ultraviolet emitting unit comprises:
a watertight body installed in an installation hole so as to ensure watertightness, the installation hole being formed in the upper plate of the bottom;
a light transmission cap configured to penetrate the watertight body while being tightly fitted with the watertight body, the light transmission cap being made of a material capable of transmitting ultraviolet rays and having an upper surface exposed to the water accommodation space;
a bracket including a support member positioned in the bottom, provided to be in contact with a lower end of the watertight body and a lower end of the light transmission cap, and separably coupled to the upper plate of the bottom, and a protruding member protruding upward from the support member and inserted into the light transmission cap; and
a printed circuit board fixed to an upper surface of the protruding member and having an ultraviolet ray LED mounted thereon.

7. The electric pot of claim 6, wherein an O-ring is interposed between an inner surface of the light transmission cap and an outer surface of the protruding member.
